(19) United States
(12) Patent Application Publication
(10) Pub. No.: US 2017/0346383 A1
(43) Pub. Date: Nov. 30, 2017

(54) COAXIAL SHAFT SYSTEM

(71) Applicant: Amol Venkat Gunale, San Jose, CA (US)

(72) Inventor: Amol Venkat Gunale, San Jose, CA (US)

(21) Appl. No.: 15/164,850

(22) Filed: May 25, 2016

(51) Int. Cl. H02K 49/10; F16H 7/06; F16H 7/02

(52) U.S. Cl. CPC H02K 49/106; F16H 7/02; F16H 7/06

(57) ABSTRACT

A coaxial shaft system includes an inner shaft and an outer shaft. The inner shaft includes a first plurality of magnets. An outer shaft is located coaxially around at least a portion of the inner shaft. The outer shaft includes a second plurality of magnets. The second plurality of magnets faces towards the first plurality of magnets. A support system supports the inner shaft and the outer shaft so that the inner shaft does not come into physical contact with the outer shaft. A number and location of the first plurality of magnets and the second plurality of magnets are configured so that for every magnet in the first plurality of magnets there is a corresponding magnet in the second plurality of magnets that together form a closely proximate magnetically attractive pair that have opposite poles in close proximity.

### BACKGROUND

In an automobile or a motorcycle, a power source such as an engine or electric motor is connected to a power transmission system. Such a transmission system is typically consists of a multispeed gearbox and a differential in the case of four wheel vehicles. The gearbox provides various levels of torque and speed to each driven wheel based on a set of gears chosen by the operator. In such systems, all the parts in path of power transmission are in physical contact with each other. Physical contact of parts offers force of friction which opposes the force in a direction opposite to that produced by the engine. Forces of friction caused by physical contact lead to power losses along the path of power transmission.

### BRIEF DESCRIPTION OF THE DRAWINGS

FIG. 1 is a simplified block diagram giving an overview of a system where power from a machine such as an engine or electric motor is mechanically transmitted to a coaxial shaft is used to rotate a wheel in accordance with an implementation.

FIG. 2, FIG. 3, FIG. 4 and FIG. 5 show a first configuration for magnetic coupling of coaxial shafts in accordance with an implementation.

FIG. 6, FIG. 7, FIG. 8 and FIG. 9 show a second configuration for magnetic coupling of coaxial shafts in accordance with an implementation.

FIG. 10, FIG. 11 and FIG. 12 show a third configuration for magnetic coupling of coaxial shafts in accordance with an implementation.

FIG. 13, FIG. 14 and FIG. 15 show a fourth configuration for magnetic coupling of coaxial shafts in accordance with an implementation.

FIG. 16, FIG. 17, FIG. 18, FIG. 19 and FIG. 20 show a fifth configuration for magnetic coupling of coaxial shafts in accordance with an implementation.

FIG. 21, FIG. 22, FIG. 23, FIG. 24 and FIG. 25 show a sixth configuration for magnetic coupling of coaxial shafts in accordance with an implementation.

FIG. 26, FIG. 27, FIG. 28, FIG. 29 and FIG. 30 show a seventh configuration for magnetic coupling of coaxial shafts in accordance with an implementation.

FIG. 31, FIG. 32, FIG. 33, FIG. 34 and FIG. 35 show an eighth configuration for magnetic coupling of coaxial shafts in accordance with an implementation.

FIG. 36 is a simplified block diagram giving an overview of a system where power from an electric motor mechanically transmitted to a coaxial shaft is used to rotate a wheel in accordance with an implementation.

### DESCRIPTION OF THE EMBODIMENTS

In one implementation of a coaxial shaft system, an outer hollow shaft includes magnets located on its inner circumference. The magnets can be either permanent magnets or electromagnets. An inner shaft includes permanent magnets or electro-magnets located on its outer circumference. The number and location of magnets on the outer hollow shaft and the inner shaft match so for every magnet on the outer shaft there is a magnet on the inner shaft in a corresponding position. Location of the poles of the magnets are selected so that every magnet is part of a closely proximate magnetically attractive pair with one magnet of the pair being on the inner surface of the outer shaft and and one magnet of the pair being on the outer surface of the inner shaft, with magnetic poles of the magnets being positioned to maximize the magnetic attraction between magnets of the pair.

The length of the outer shaft is typically less than the inner shaft so that inner shaft extends out of the outer shaft in a least one location. Each shaft is supported by sets of bearings. A small air gap is maintained between the inner surface of the outer shaft and the outer surface of the inner shaft so there is no direct physical connection between the outer shaft and the inner shaft. The outer shaft and the inner shaft are magnetically coupled due to attraction between two opposite magnetic field poles of permanent/electromagnet mounted on each shaft. For example, electromagnets are implemented by wire coils that receive direct current (DC) via slip rings mounted on the shafts. For example, the orientation of magnetic field is decided by right hand rule. The direction of flow of DC current is purposely controlled so as to create a particular magnetic field pole (north or south) pointing towards the corresponding opposite pole created/mounted on the other shaft.

For example, a driving torque can be applied to either the outer shaft or the inner shaft depending on requirements of each particular system design. Once the driving torque is applied to rotate one of the shafts, the other shaft will also rotate because of attractive force between two opposite magnetic poles mounted or created on the shafts. The torque is transmitted by using force of attraction between two opposite magnetic poles mounted on coaxial shafts.

For example, where no load is applied to the inner shaft, driving torque is applied to outer shaft. A certain value of torque is required to move the inner shaft even when no load is connected to inner shaft. The value of torque needed is directly proportional to force of attraction between magnetic poles mounted/created between two coaxial shafts. If the force of attraction between magnetic poles mounted or created on coaxial shafts is not enough to transfer the torque required to rotate inner shaft, then the outer shaft will be decoupled from inner shaft and no torque will be transferred from the outer shaft to the inner shaft.

For example, where a certain load is applied to the inner shaft, driving torque is applied to the outer shaft. A certain value of torque is required to rotate the load mounted on the inner shaft. The value of torque needed to rotate the load mounted on the inner shaft is directly proportional to force of attraction between magnetic poles mounted or created on coaxial shafts. If the force of attraction between magnetic poles mounted/created on coaxial shafts is not enough to transfer the torque required to rotate the load mounted on inner shaft, then the outer shaft will be decoupled from the inner shaft and no torque will be transferred from the outer shaft to the inner shaft. In this case the load on the inner shaft will fail to rotate. A minimum value of strength of magnetic field is required between the magnet or electromagnet mounted or created on the coaxial shafts in order to achieve magnetic coupling between the two shafts to transfer the torque from one shaft to another.

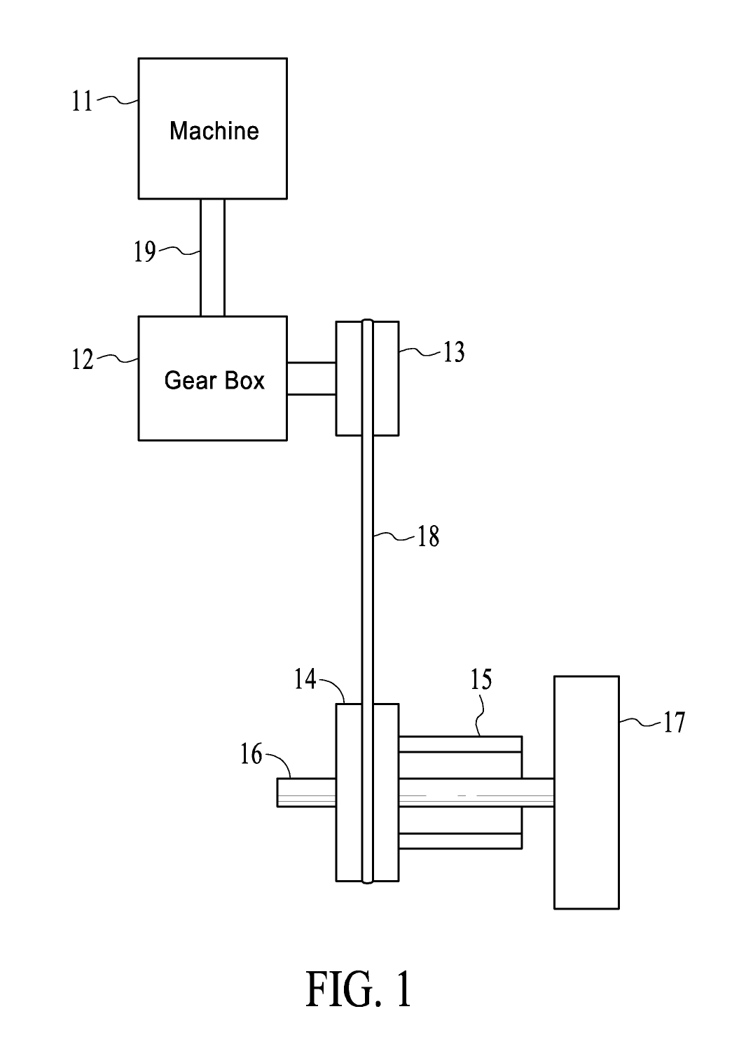

FIG. 1 is a simplified block diagram showing a machine 11 and a power transmission system supplying the power from machine 11 to a coaxial shaft system. Machine 11 is a machine that supplies motive power such as an engine or an electric motor. The electric motor may be alternating current (AC) or direct current (DC). A connection 19 illustrates power from machine 11 being mechanically transmitted to a gear box 12. A pulley or sprocket system is used to mechanically transmit power from gear box 12 to the coaxial shaft system. Specifically, gear box rotates a pulley or sprocket 13. The power generated by rotation of pulley or sprocket 13 is transmitted via a belt or a chain 18 to a pulley or sprocket 14 connected to an outer shaft 15. Outer shaft 15 is magnetically coupled to an inner shaft 16. As pulley or sprocket 14 rotates, rotating outer shaft 15, torque from outer shaft 15 is magnetically transmitted to inner shaft 16. As inner shaft 16 rotates, a wheel 17 rotates.

While in FIG. 1 a two pulley or two sprocket system is showed used to transfer power to outer shaft 15, additional pulleys can be used. For example, as is well understood in the art, a system with two belts and four pulleys, or two chains and four sprockets can be used to transmit power. Any other known pulley or sprocket system configuration can also be used.

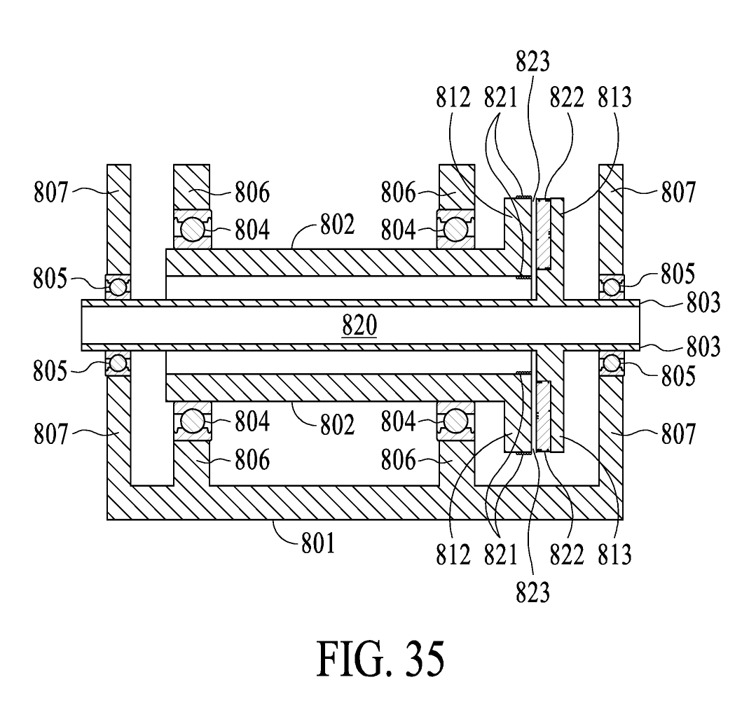

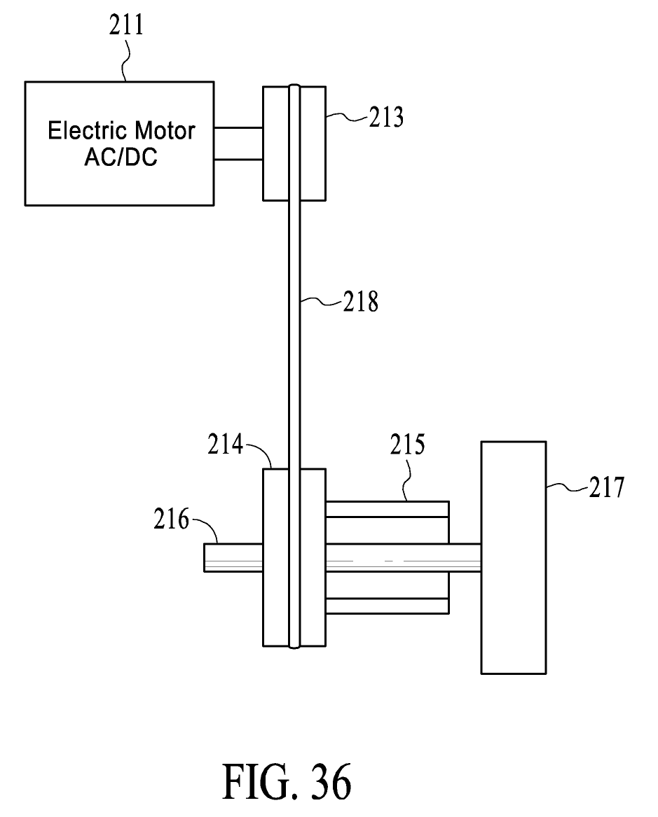

FIG. 36 is a simplified block diagram showing an electric motor 211 that can be either alternating current (AC) or direct current (DC) powered. Mechanical power generated by electric motor 211 rotates a pulley or sprocket 213. The power generated by rotation of pulley or sprocket 213 is transmitted via a belt or a chain 218 to a pulley or sprocket 214 connected to an outer shaft 215, to form a power transmission system for the implementation shown in FIG. 36.

Outer shaft 215 is magnetically coupled to an inner shaft 216. As pulley or sprocket 214 rotates, rotating outer shaft 215, torque from outer shaft 215 is magnetically transmitted to inner shaft 216. As inner shaft 216 rotates, a wheel 217 rotates.

While in FIG. 36, a two pulley or two sprocket system is showed used to transfer power to outer shaft 215, additional pulleys can be used. For example, as is well understood in the art, a system with two belts and four pulleys, or two chains and four sprockets can be used to transmit power. Any other known pulley or sprocket system configuration can also be used.

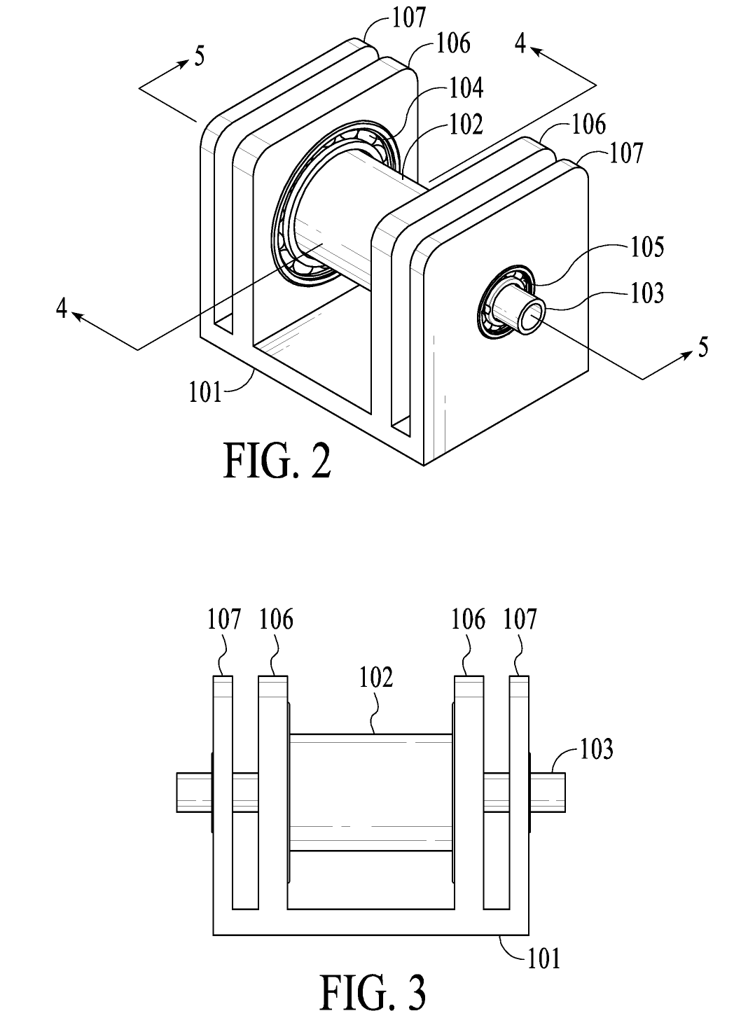

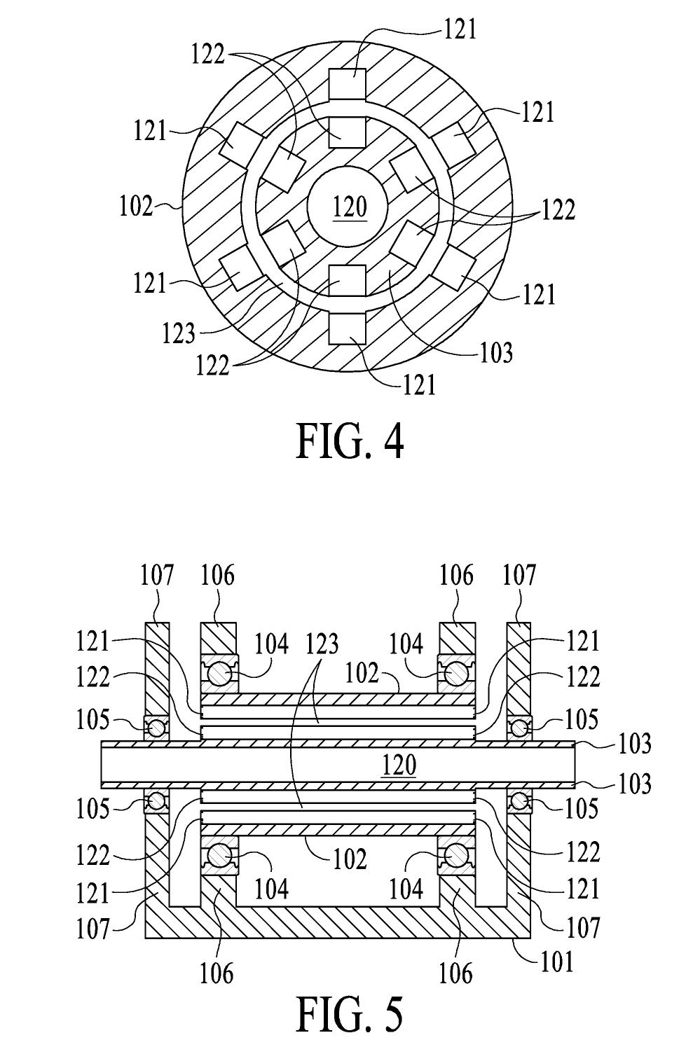

FIG. 2, FIG. 3, FIG. 4 and FIG. 5 show a first configuration for magnetic coupling of coaxial shafts. An inner shaft 103 is mounted on bearings 105 located on support structures 107 of a support system 101. An outer shaft 102 is mounted on bearings 104 located on support structures 106 of support system 101. Center 120 of inner shaft 103 is, for example, hollow. Alternatively, the inner shaft is not hollow.

As shown in FIG. 4, a number of permanent magnets 121 are mounted on an inner circumference of outer shaft 102. An equal number of permanent magnets 122 are mounted on an outer circumference of inner shaft 103. Permanent magnets 121 are spaced on the inner circumference of outer shaft 102 and permanent magnets 122 are spaced on the outer circumference of inner shaft 103 to allow for alignment of permanent magnets 121 and permanent magnets 122 into attracting magnet pairs to maximize the magnetic force between outer shaft 102 and inner shaft 103. An air gap 123 separates the magnets in a magnet pair from each other. For example, air gap 123 is filled with air.

For example, there is an even number of permanent magnets 121 and an equal even number of permanent magnets 122. Pole directions of permanent magnets 121 are alternated so that half of permanent magnets 121 have south poles facing inward toward inner shaft 103 and half of permanent magnets 121 have north poles facing inward toward inner shaft 103. Likewise, pole directions of permanent magnets 122 are alternated so that half of permanent magnets 122 have south poles facing outward toward outer shaft 103 and half of permanent magnets 122 have north poles facing outward toward outer shaft 103. Other arrangements of permanent magnets 121 and permanent magnets 122 also can be used provided spacing and pole arrangement of permanent magnets 121 and permanent magnets 122 allow for all the permanent magnets to be aligned into matching attracting pairs of magnets. For example, all of permanent magnets 121 have south poles facing inward toward inner shaft 103 and all of permanent magnets 122 have north poles facing outward toward outer shaft 102.

The matching attracting magnetic pairs provide a magnetic bond between inner shaft 103 and outer shaft 102 so that even though there is no physical contact between inner shaft 103 and outer shaft 102, torque placed on outer shaft 102 is transmitted to inner shaft 103 and torque placed on inner shaft 103 is transmitted to outer shaft 102. The permanent magnets are selected based on strength of their magnetic fields in order to meet torque requirements of a particular application.

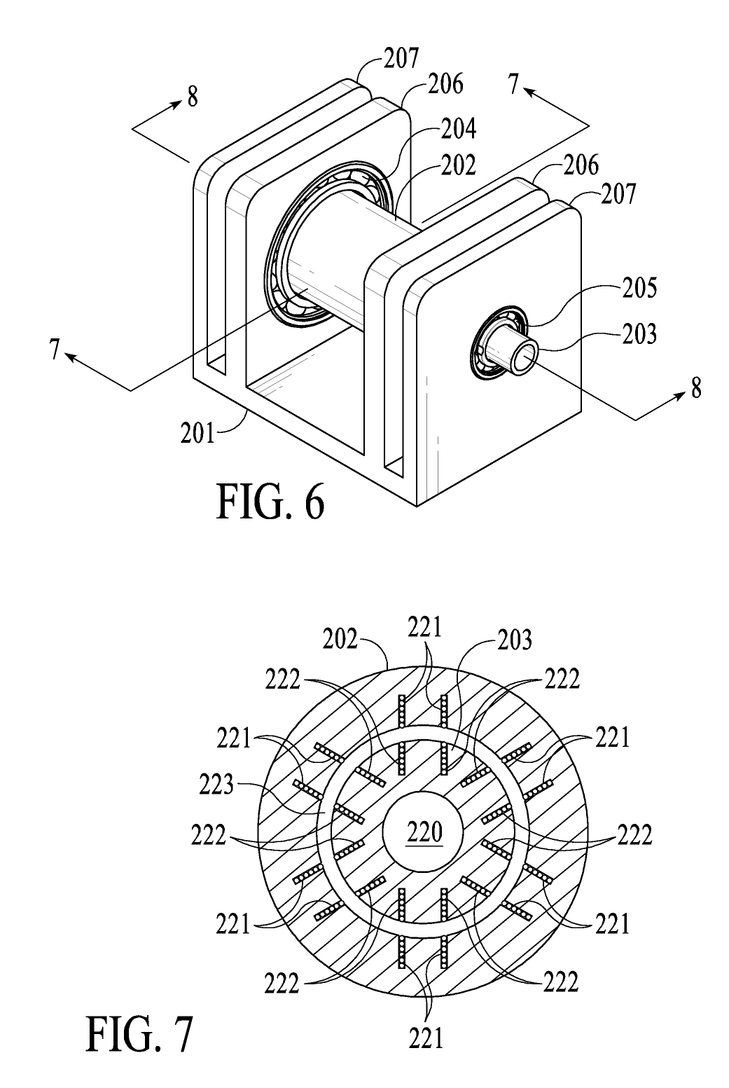

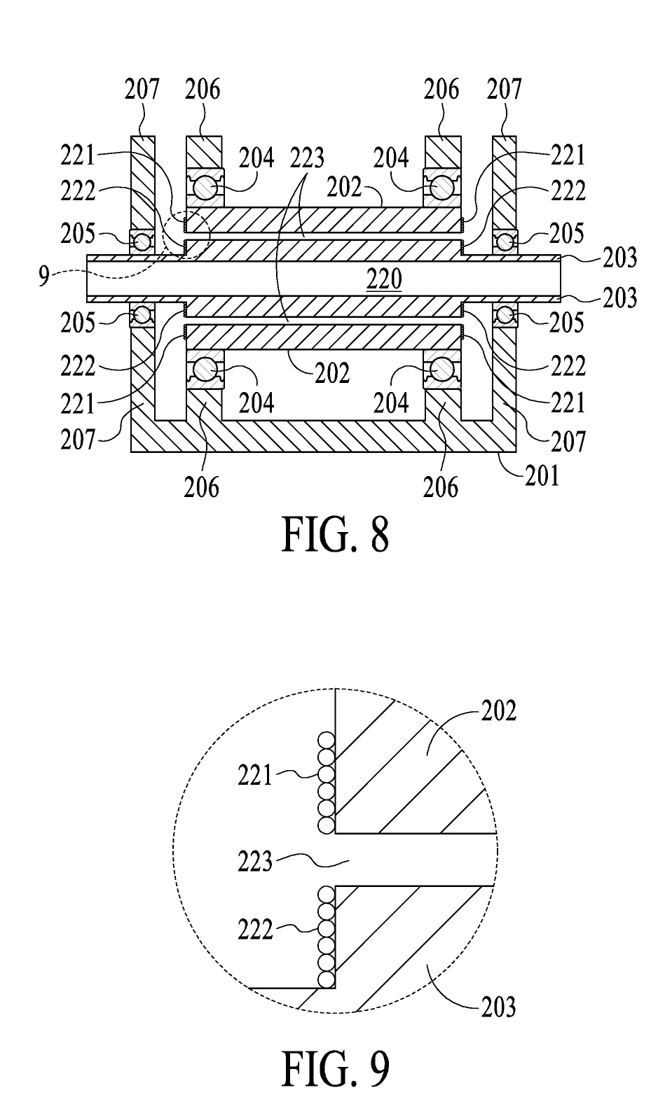

FIG. 6, FIG. 7, FIG. 8 and FIG. 9 show a second configuration for magnetic coupling of coaxial shafts. An inner shaft 203 is mounted on bearings 205 located on support structures 207 of a support system 201. An outer shaft 202 is mounted on bearings 204 located on support structures 206 of support system 201. Center 220 of inner shaft 203 is, for example, hollow. Alternatively, the inner shaft is not hollow.

As shown in FIG. 7, a number of electromagnets 221 are mounted on an inner circumference of outer shaft 202. An equal number of electromagnets 222 are mounted on an outer circumference of inner shaft 203. Electromagnets 221 are spaced on the inner circumference of outer shaft 202 and electromagnets 222 are spaced on the outer circumference of inner shaft 203 to allow for alignment of electromagnets 221 and electromagnets 222 into attracting magnet pairs to maximize the magnetic force between outer shaft 202 and inner shaft 203. For example, in one implementation, there is an even number of electromagnets 221 and an equal even number of electromagnets 222. Pole directions of electromagnets 221 are alternated so that half of electromagnets 221 have south poles facing inward toward inner shaft 203 and half of electromagnets 221 have north poles facing inward toward inner shaft 203. Likewise, pole directions of electromagnets magnets 222 are alternated so that half of electromagnets 222 have south poles facing outward toward outer shaft 203 and half of electromagnets 222 have north poles facing outward toward outer shaft 203. An air gap 223 separates the magnets in a magnet pair from each other.

Other arrangements of electromagnets 221 and electromagnets 222 also can be used provided spacing and pole arrangement of electromagnets 221 and electromagnets 222 allow for all the electromagnets to be aligned into matching attracting pairs of magnets. For example, all of electromagnets 221 have north poles facing inward toward inner shaft 203 and all of electromagnets 222 have south poles facing outward toward outer shaft 202.

The matching attracting magnetic pairs provide a magnetic bond between inner shaft 203 and outer shaft 202 so that even though there is no physical contact between inner shaft 203 and outer shaft 202, torque placed on outer shaft 202 is transmitted to inner shaft 203 and torque placed on inner shaft 203 is transmitted to outer shaft 202

For example, electromagnets 221 and electromagnets 222 are implemented by wire coils that receive direct current (DC) via slip rings mounted on inner shaft 203 and outer shaft 202. The strength of magnetic field for each electromagnet is selected to provide magnetic bond suitable for a particular application.

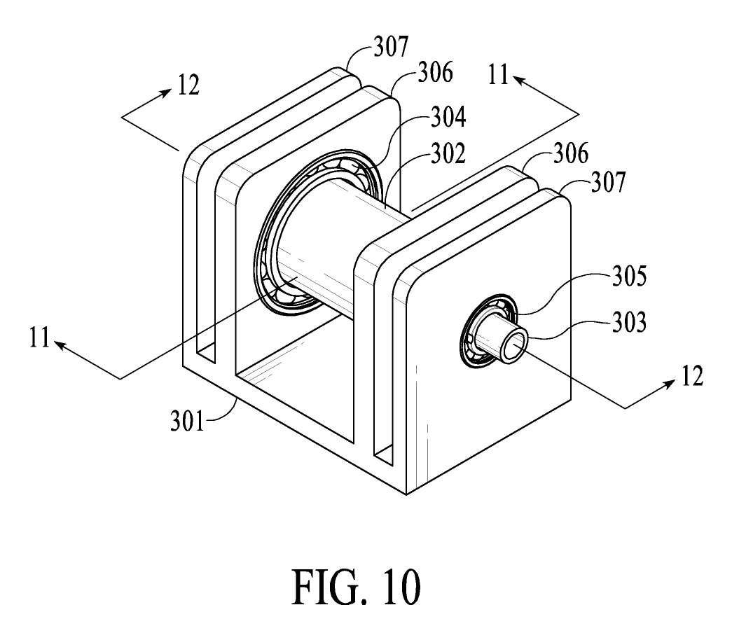

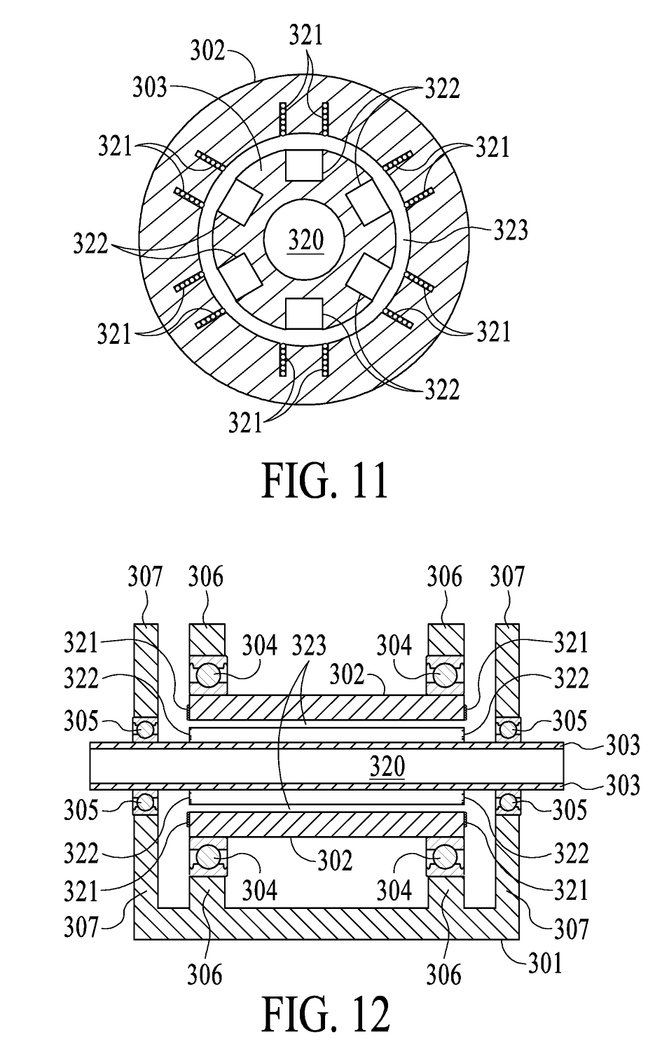

FIG. 10, FIG. 11 and FIG. 12 show a third configuration for magnetic coupling of coaxial shafts in accordance with an implementation. An inner shaft 303 is mounted on bearings 305 located on support structures 307 of a support system 301. An outer shaft 302 is mounted on bearings 304 located on support structures 306 of support system 301. Center 320 of inner shaft 303 is, for example, hollow. Alternatively, the inner shaft is not hollow.

As shown in FIG. 11, a number of electromagnets 321 are mounted on an inner circumference of outer shaft 302. An equal number of permanent magnets 322 are mounted on an outer circumference of inner shaft 303. Electromagnets 321 are spaced on the inner circumference of outer shaft 302 and permanent magnets 322 are spaced on the outer circumference of inner shaft 303 to allow for alignment of electromagnets 321 and permanent magnets 322 into attracting magnet pairs to maximize the magnetic force between outer shaft 302 and inner shaft 303. For example, in one implementation, there is an even number of electromagnets 321 and an equal even number of permanent magnets 322. Pole directions of electromagnets 321 are alternated so that half of electromagnets 321 have south poles facing inward toward inner shaft 303 and half of electromagnets 321 have north poles facing inward toward inner shaft 303. Likewise, pole directions of permanent magnets 322 are alternated so that half of permanent magnets 322 have south poles facing outward toward outer shaft 303 and half of permanent magnets 322 have north poles facing outward toward outer shaft 303. An air gap 323 separates the magnets in a magnet pair from each other.

Other arrangements of electromagnets 321 and permanent magnets 322 also can be used provided spacing and pole arrangement of electromagnets 321 and permanent magnets 322 allow for all the electromagnets and permanent magnets to be aligned into matching attracting pairs of magnets. For example, all of electromagnets 321 have south poles facing inward toward inner shaft 303 and all of permanent magnets 322 have north poles facing outward toward outer shaft 302.

The matching attracting magnetic pairs provide a magnetic bond between inner shaft 303 and outer shaft 302 so that even though there is no physical contact between inner shaft 303 and outer shaft 302, torque placed on outer shaft 302 is transmitted to inner shaft 303 and torque placed on inner shaft 303 is transmitted to outer shaft 302

For example, electromagnets 321 are implemented by wire coils that receive direct current (DC) via slip rings mounted on outer shaft 302. The strength of magnetic field for each electromagnet is selected to provide magnetic bond suitable for a particular application.

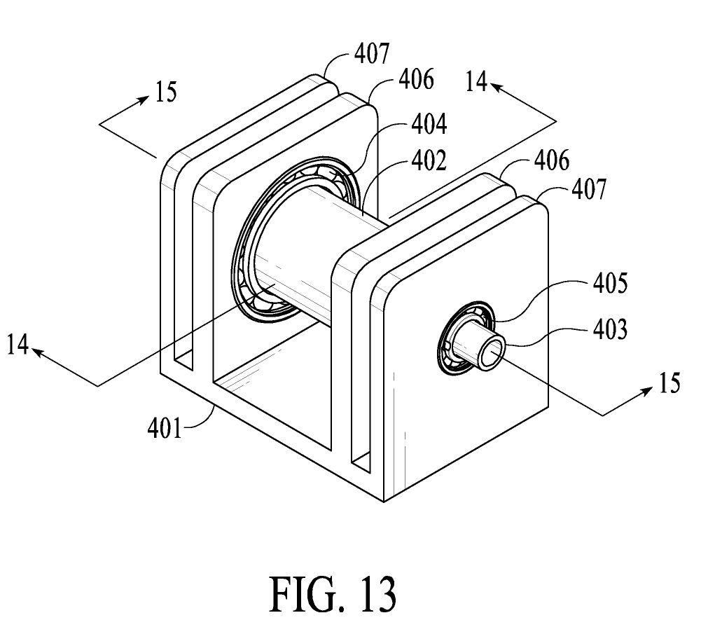

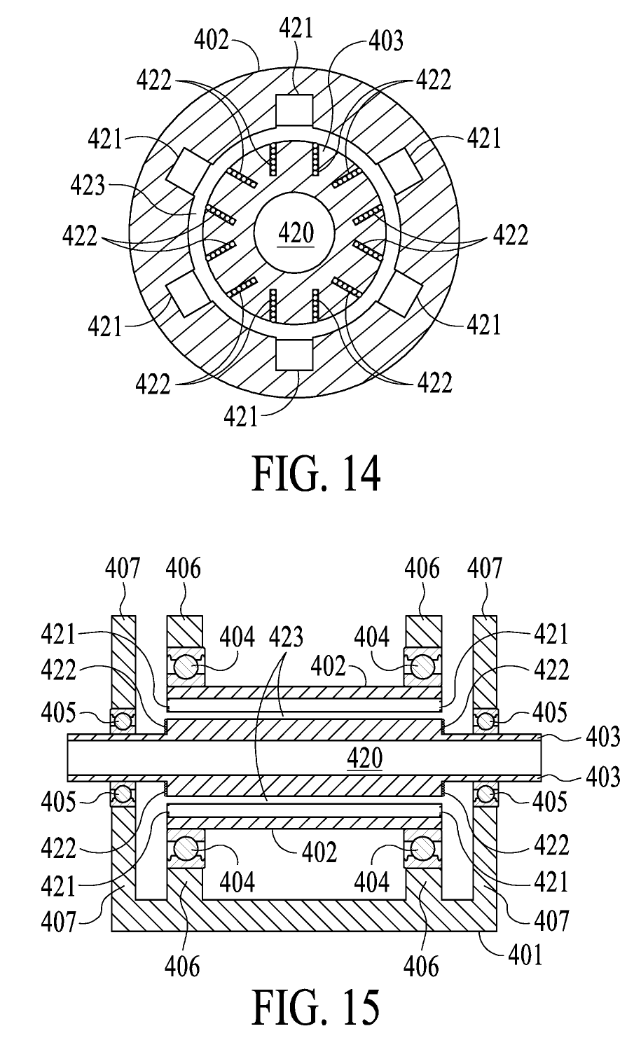

FIG. 13, FIG. 14 and FIG. 15 show a fourth configuration for magnetic coupling of coaxial shafts in accordance with an implementation. An inner shaft 403 is mounted on bearings 405 located on support structures 407 of a support system 401. An outer shaft 402 is mounted on bearings 404 located on support structures 406 of support system 401. Center 420 of inner shaft 403 is, for example, hollow. Alternatively, the inner shaft is not hollow.

As shown in FIG. 14, a number of permanent magnets 421 are mounted on an inner circumference of outer shaft 402. An equal number of electromagnets 422 are mounted on an outer circumference of inner shaft 403. Permanent magnets 421 are spaced on the inner circumference of outer shaft 402 and electromagnets 422 are spaced on the outer circumference of inner shaft 403 to allow for alignment of permanent magnets 421 and electromagnets 422 into attracting magnet pairs to maximize the magnetic force between outer shaft 402 and inner shaft 403. For example, in one implementation, there is an even number of permanent magnets 421 and an equal even number of electromagnets 422. Pole directions of permanent magnets 421 are alternated so that half of permanent magnets 421 have south poles facing inward toward inner shaft 403 and half of permanent magnets 421 have north poles facing inward toward inner shaft 403. Likewise, pole directions of electromagnets magnets 422 are alternated so that half of electromagnets 422 have south poles facing outward toward outer shaft 403 and half of electromagnets 422 have north poles facing outward toward outer shaft 403. An air gap 423 separates the magnets in a magnet pair from each other.

Other arrangements of permanent magnets 421 and electromagnets 422 also can be used provided spacing and pole arrangement of permanent magnets 421 and electromagnets 422 allow for all the electromagnets and permanent magnets to be aligned into matching attracting pairs of magnets. For example, all of permanent magnets 421 have south poles facing inward toward inner shaft 403 and all of electromagnets 422 have north poles facing outward toward outer shaft 402.

The matching attracting magnetic pairs provide a magnetic bond between inner shaft 403 and outer shaft 402 so that even though there is no physical contact between inner shaft 403 and outer shaft 402, torque placed on outer shaft 402 is transmitted to inner shaft 403 and torque placed on inner shaft 403 is transmitted to outer shaft 402

For example, electromagnets 422 are implemented by wire coils that receive direct current (DC) via slip rings mounted on inner shaft 403. The strength of magnetic field for each electromagnet is selected to provide magnetic bond suitable for a particular application.

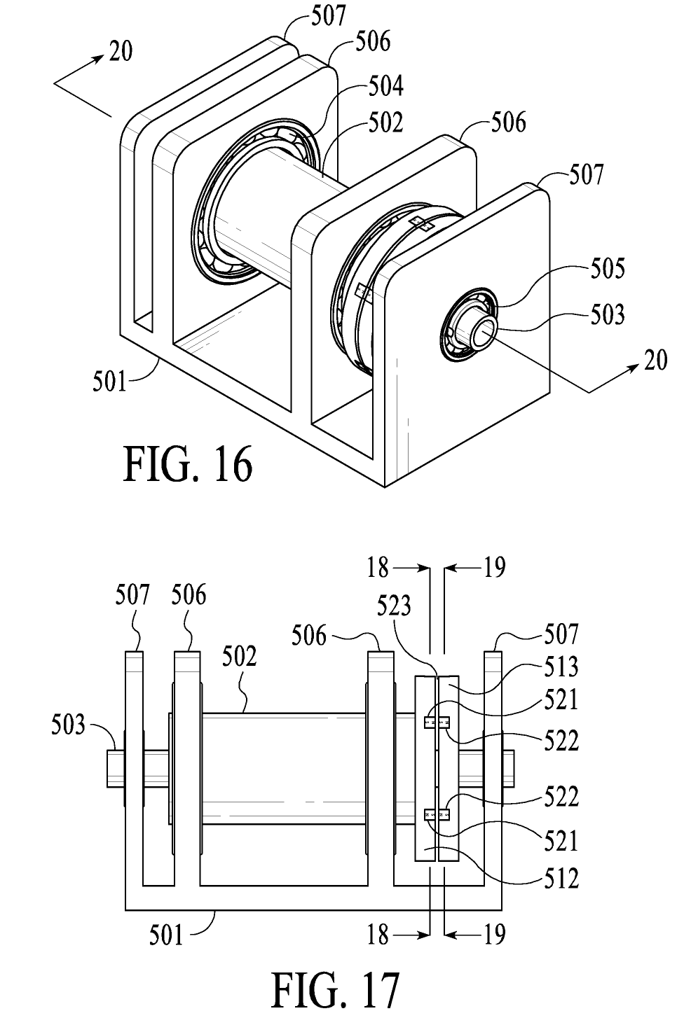

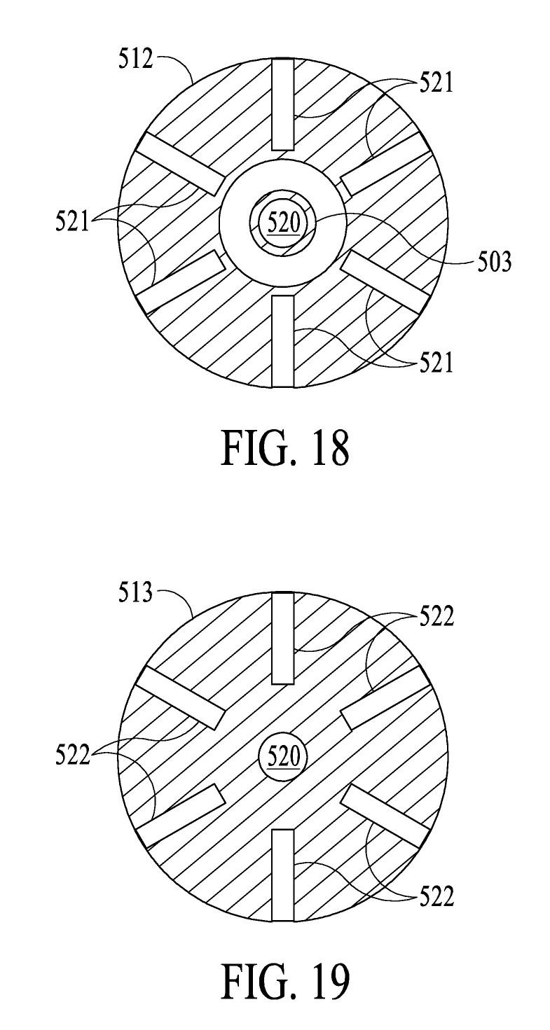

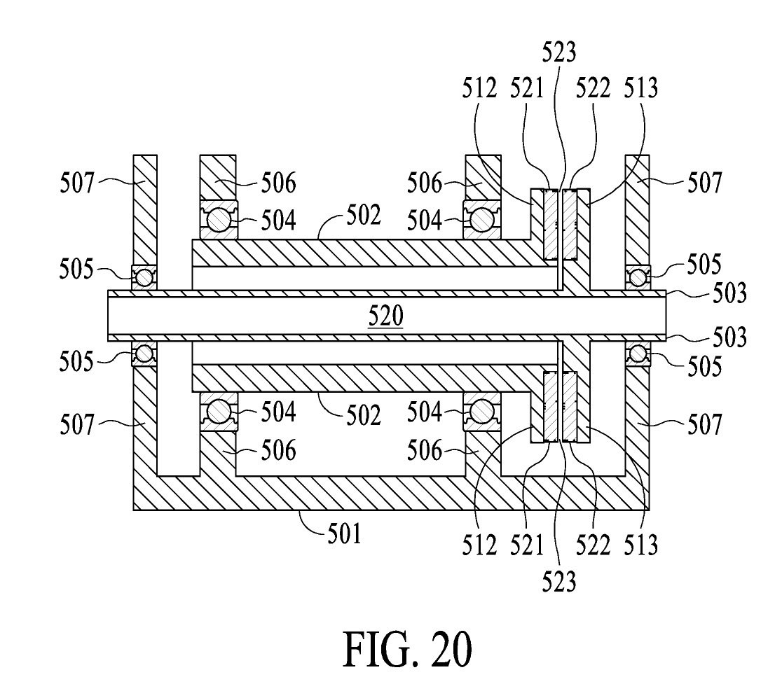

FIG. 16, FIG. 17, FIG. 18, FIG. 19 and FIG. 20 show a fifth configuration for magnetic coupling of coaxial shafts in accordance with an implementation. An inner shaft 503 is mounted on bearings 505 located on support structures 507 of a support system 501. An outer shaft 502 is mounted on bearings 504 located on support structures 506 of support system 501. Center 520 of inner shaft 503 is, for example, hollow. Alternatively, the inner shaft is not hollow.

As shown in FIG. 17, FIG. 18 and FIG. 19, a number of permanent magnets 521 are mounted on a disk surface 512 facing outward from outer shaft 502. An equal number of permanent magnets 522 are mounted on a disk surface 513 attached to inner shaft 503 and facing toward permanent magnets 521 of disk surface 512. Permanent magnets 521 are spaced on disk surface 512 and permanent magnets 522 are spaced on disk surface 513 to allow for alignment of permanent magnets 521 and permanent magnets 522 into attracting magnet pairs to maximize the magnetic force between disk surface 512 and disk surface 513, and thus between outer shaft 502 and inner shaft 503. For example, in one implementation, there is an even number of permanent magnets 521 and an equal even number of permanent magnets 522. Pole directions of permanent magnets 521 are alternated so that half of permanent magnets 521 have south poles facing disk surface 513 and half of permanent magnets 521 have north poles facing disk surface 513. Likewise, pole directions of permanent magnets 522 are alternated so that half of permanent magnets 522 have south poles facing disk surface 512 and half of permanent magnets 522 have north poles facing disk surface 512. An air gap 523 separates the magnets in a magnet pair from each other.

Other arrangements of permanent magnets 521 and permanent magnets 522 also can be used provided spacing and pole arrangement of permanent magnets 521 and permanent magnets 522 allow for all the permanent magnets to be aligned into matching attracting pairs of magnets. For example, all of permanent magnets 521 have south poles facing inward disk surface 513 and all of permanent magnets 522 have north poles facing disk surface 512.

The matching attracting magnetic pairs provide a magnetic bond between inner shaft 503 and outer shaft 502 (via disk surface 512 and disk surface 513) so that even though there is no physical contact between inner shaft 503 and outer shaft 502, torque placed on outer shaft 502 is transmitted to inner shaft 503 and torque placed on inner shaft 503 is transmitted to outer shaft 502. The permanent magnets are selected based on strength of their magnetic fields in order to meet torque requirements of a particular application.

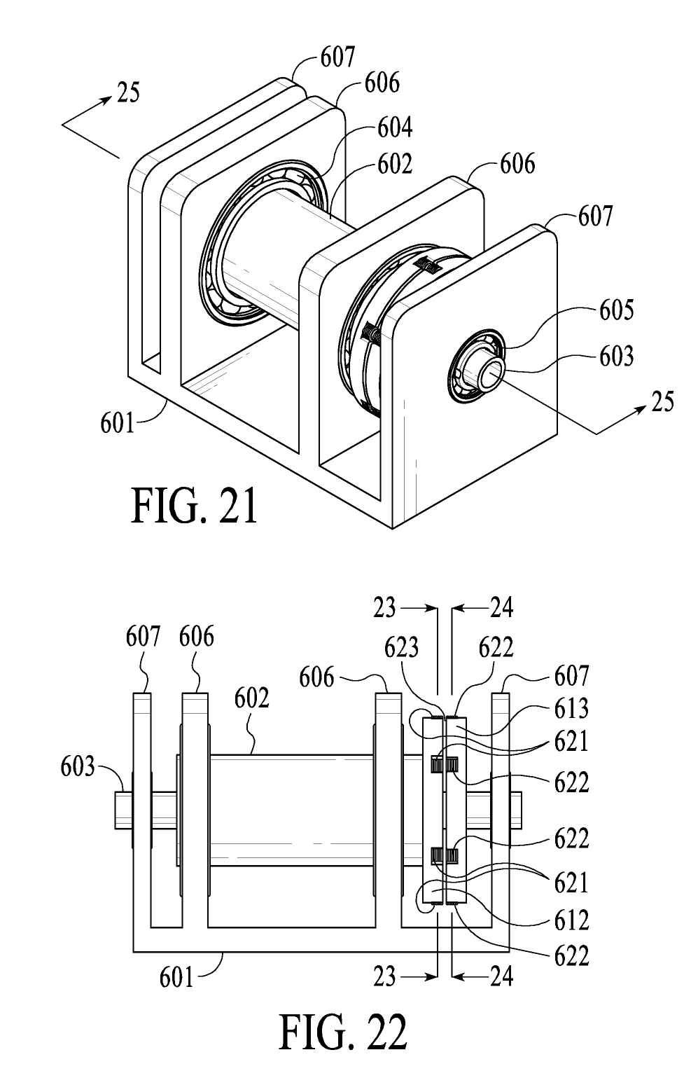

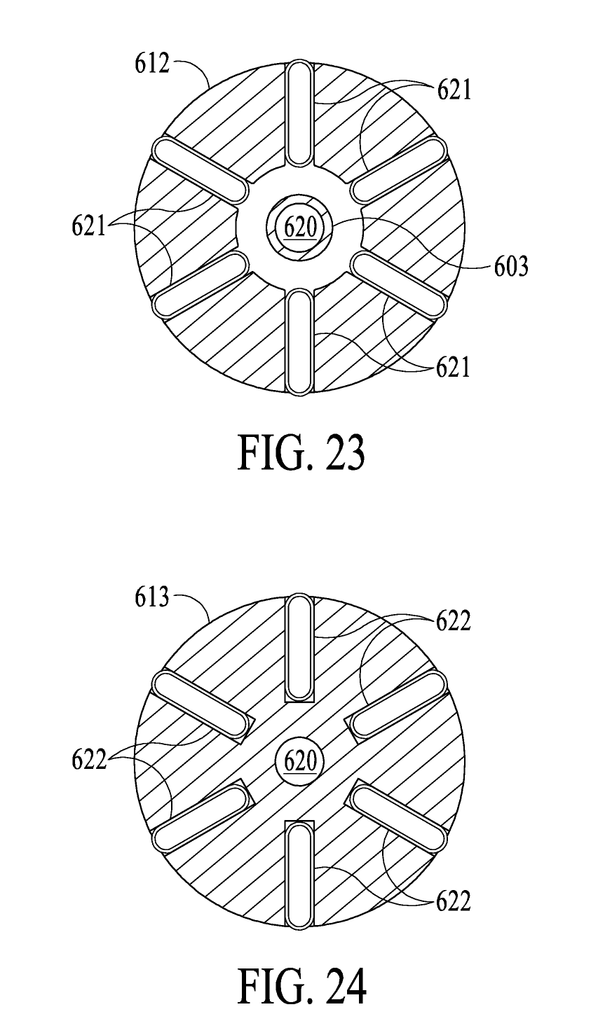

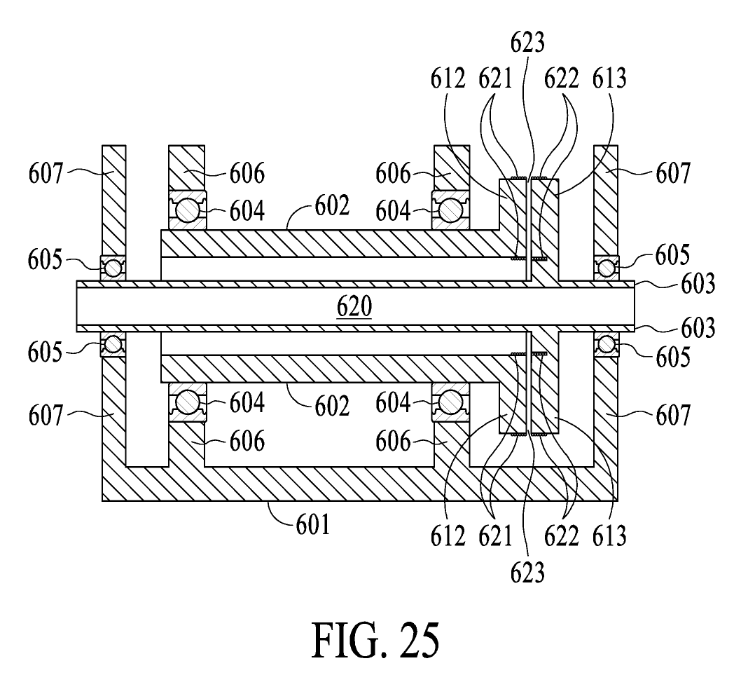

FIG. 21, FIG. 22, FIG. 23, FIG. 24 and FIG. 25 show a sixth configuration for magnetic coupling of coaxial. An inner shaft 603 is mounted on bearings 605 located on support structures 607 of a support system 601. An outer shaft 602 is mounted on bearings 604 located on support structures 606 of support system 601. Center 620 of inner shaft 603 is, for example, hollow. Alternatively, the inner shaft is not hollow.

As shown in FIG. 22, FIG. 23 and FIG. 24, a number of electromagnets 621 are mounted on a disk surface 612 facing outward from outer shaft 602. An equal number of electromagnets 622 are mounted on a disk surface 613 attached to inner shaft 603 and facing toward electromagnets 621 of disk surface 612. Electromagnets 621 are spaced on disk surface 612 and electromagnets 622 are spaced on disk surface 613 to allow for alignment of electromagnets 621 and electromagnets 622 into attracting magnet pairs to maximize the magnetic force between disk surface 612 and disk surface 613, and thus between outer shaft 602 and inner shaft 603. For example, in one implementation, there is an even number of electromagnets 621 and an equal even number of electromagnets 622. Pole directions of electromagnets 621 are alternated so that half of electromagnets 621 have south poles facing disk surface 613 and half of electromagnets 621 have north poles facing disk surface 613. Likewise, pole directions of electromagnets 622 are alternated so that half of electromagnets 622 have south poles facing disk surface 612 and half of electromagnets 622 have north poles facing disk surface 612. An air gap 623 separates the magnets in a magnet pair from each other.

Other arrangements of electromagnets 621 and electromagnets 622 also can be used provided spacing and pole arrangement of electromagnets 621 and electromagnets 622 allow for all the electromagnets to be aligned into matching attracting pairs of magnets. For example, all of electromagnets 621 have north poles facing disk surface 613 and all of electromagnets 622 have south poles facing disk surface 612.

The matching attracting magnetic pairs provide a magnetic bond between inner shaft 603 and outer shaft 602 (via disk surface 612 and disk surface 613) so that even though there is no physical contact between inner shaft 603 and outer shaft 602, torque placed on outer shaft 602 is transmitted to inner shaft 603 and torque placed on inner shaft 603 is transmitted to outer shaft 602.

For example, electromagnets 621 and electromagnets 622 are implemented by wire coils that receive direct current (DC) via slip rings mounted on inner shaft 603 and outer shaft 602. The strength of magnetic field for each electromagnet is selected to provide magnetic bond suitable for a particular application.

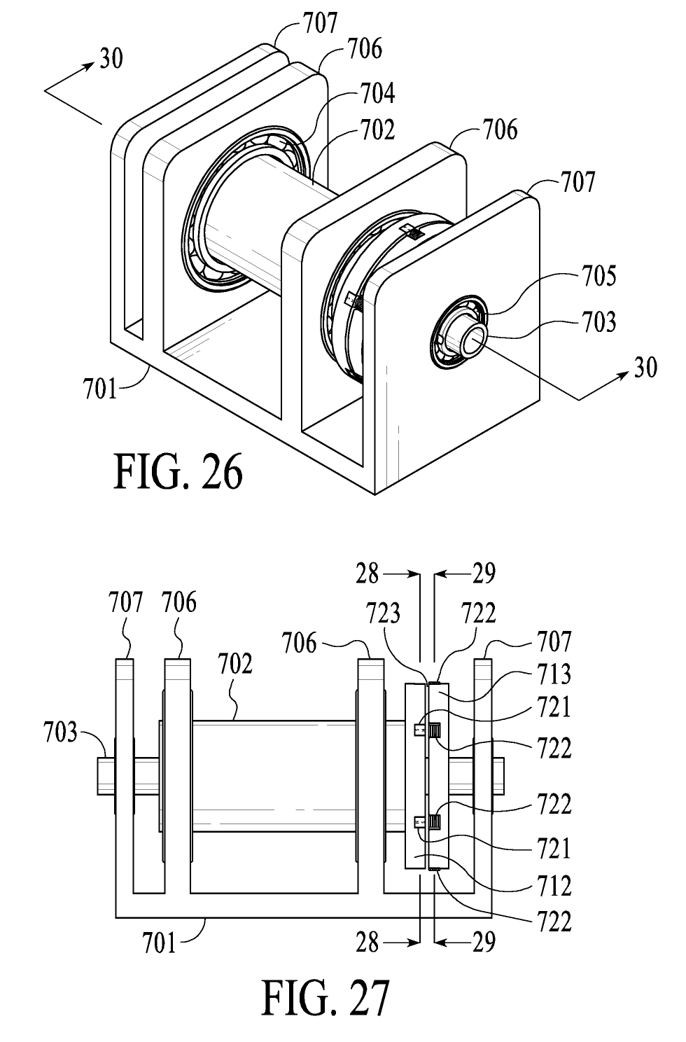

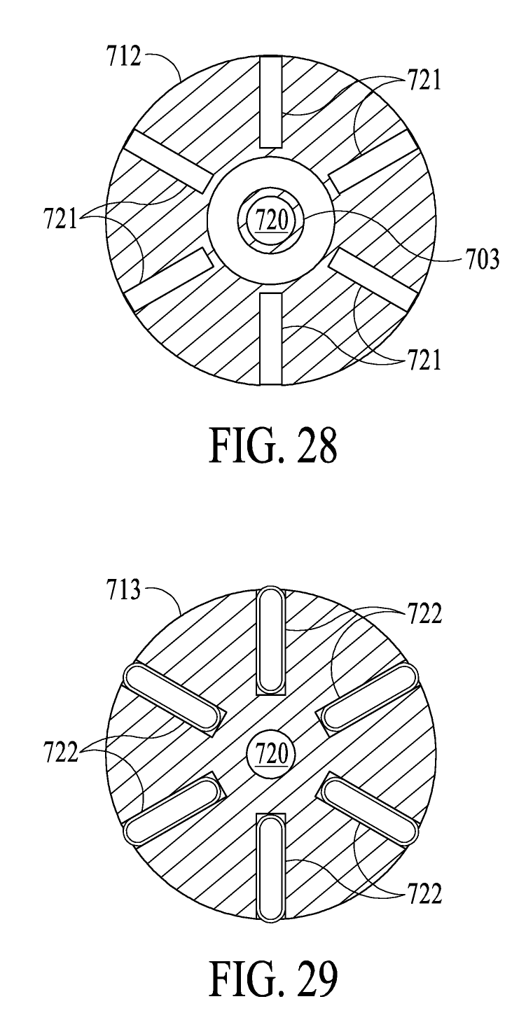

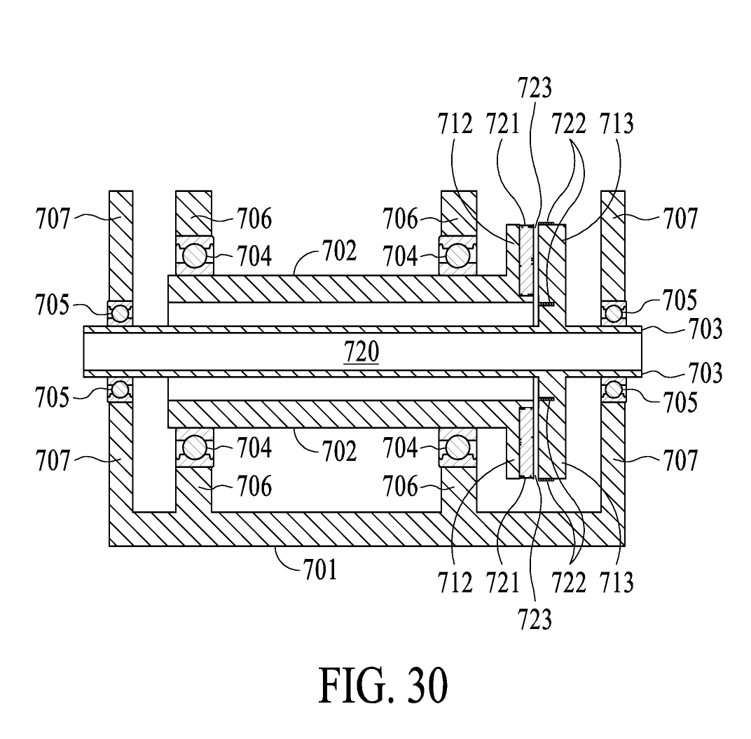

FIG. 26, FIG. 27, FIG. 28, FIG. 29 and FIG. 30 show a seventh configuration for magnetic coupling of coaxial.

An inner shaft 703 is mounted on bearings 705 located on support structures 707 of a support system 701. An outer shaft 702 is mounted on bearings 704 located on support structures 706 of support system 701. Center 720 of inner shaft 703 is, for example, hollow. Alternatively, the inner shaft is not hollow.

As shown in FIG. 27, FIG. 28 and FIG. 29, a number of permanent magnets 721 are mounted on a disk surface 712 facing outward from outer shaft 702. An equal number of electromagnets 722 are mounted on a disk surface 713 attached to inner shaft 703 and facing toward permanent magnets 721 of disk surface 712. Permanent magnets 721 are spaced on disk surface 712 and electromagnets 722 are spaced on disk surface 713 to allow for alignment of permanent magnets 721 and electromagnets 722 into attracting magnet pairs to maximize the magnetic force between disk surface 712 and disk surface 713, and thus between outer shaft 702 and inner shaft 703. For example, in one implementation, there is an even number of permanent magnets 721 and an equal even number of electromagnets 722. Pole directions of permanent magnets 721 are alternated so that half of permanent magnets 721 have south poles facing disk surface 713 and half of permanent magnets 721 have north poles facing disk surface 713. Likewise, pole directions of electromagnets 722 are alternated so that half of electromagnets 722 have south poles facing disk surface 712 and half of electromagnets 722 have north poles facing disk surface 712. An air gap 723 separates the magnets in a magnet pair from each other.

Other arrangements of permanent magnets 721 and electromagnets 722 also can be used provided spacing and pole arrangement of permanent magnets 721 and electromagnets 722 allow for all the electromagnets and permanent magnets to be aligned into matching attracting pairs of magnets. For example, all of permanent magnets 721 have north poles facing disk surface 713 and all of electromagnets 722 have south poles facing disk surface 712.

The matching attracting magnetic pairs provide a magnetic bond between inner shaft 703 and outer shaft 702 (via disk surface 712 and disk surface 713) so that even though there is no physical contact between inner shaft 703 and outer shaft 702, torque placed on outer shaft 702 is transmitted to inner shaft 703 and torque placed on inner shaft 703 is transmitted to outer shaft 702.

For example, electromagnets 722 are implemented by wire coils that receive direct current (DC) via slip rings mounted on inner shaft 703. The strength of magnetic field for each electromagnet is selected to provide magnetic bond suitable for a particular application.

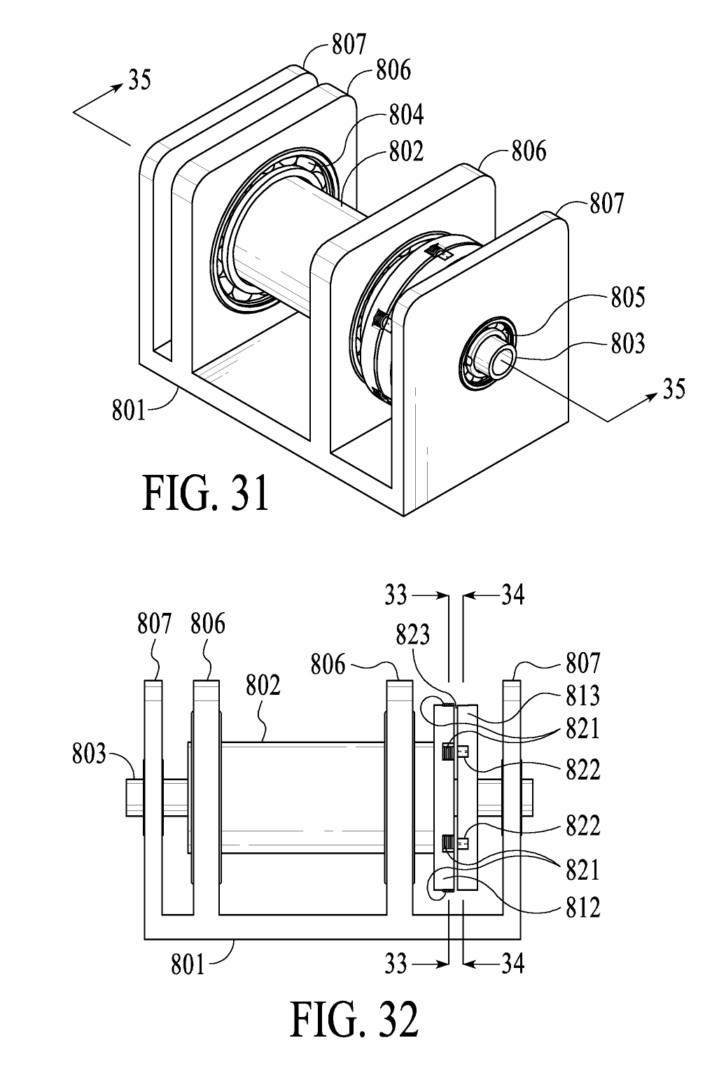

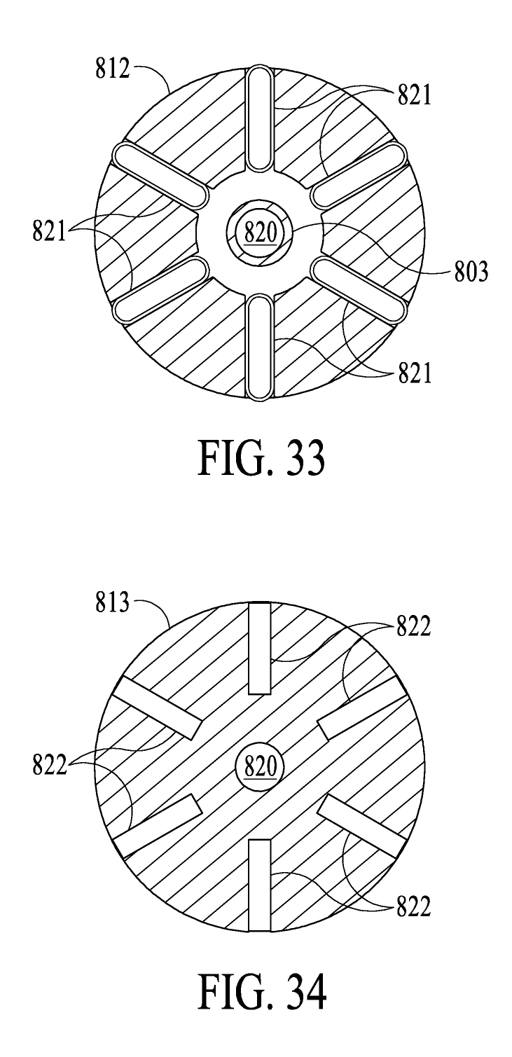

FIG. 31, FIG. 32, FIG. 33, FIG. 34 and FIG. 35 show an eighth configuration for magnetic coupling of coaxial. An inner shaft 803 is mounted on bearings 805 located on support structures 807 of a support system 801. An outer shaft 802 is mounted on bearings 804 located on support structures 806 of support system 801. Center 820 of inner shaft 803 is, for example, hollow. Alternatively, the inner shaft is not hollow.

As shown in FIG. 33, FIG. 34 and FIG. 35, a number of electromagnets 821 are mounted on a disk surface 812 facing outward from outer shaft 802. An equal number of permanent magnets 822 are mounted on a disk surface 813 attached to inner shaft 803 and facing toward electromagnets 821 of disk surface 812. Electromagnets 821 are spaced on disk surface 812 and permanent magnets 822 are spaced on disk surface 813 to allow for alignment of electromagnets 821 and permanent magnets 822 into attracting magnet pairs to maximize the magnetic force between disk surface 812 and disk surface 813, and thus between outer shaft 802 and inner shaft 803. For example, in one implementation, there is an even number of electromagnets 821 and an equal even number of permanent magnets 822. Pole directions of electromagnets 821 are alternated so that half of electromagnets 821 have south poles facing disk surface 813 and half of electromagnets 821 have north poles facing disk surface 813. Likewise, pole directions of permanent magnets 822 are alternated so that half of permanent magnets 822 have south poles facing disk surface 812 and half of permanent magnets 822 have north poles facing disk surface 812. An air gap 823 separates the magnets in a magnet pair from each other.

Other arrangements of electromagnets 821 and permanent magnets 822 also can be used provided spacing and pole arrangement of electromagnets 821 and permanent magnets 822 allow for all the electromagnets and permanent magnets to be aligned into matching attracting pairs of magnets. For example, all of electromagnets 821 have south poles facing disk surface 813 and all of permanent magnets 822 have north poles facing disk surface 812.

The matching attracting magnetic pairs provide a magnetic bond between inner shaft 803 and outer shaft 802 (via disk surface 812 and disk surface 813) so that even though there is no physical contact between inner shaft 803 and outer shaft 802, torque placed on outer shaft 802 is transmitted to inner shaft 803 and torque placed on inner shaft 803 is transmitted to outer shaft 802.

For example, electromagnets 821 are implemented by wire coils that receive direct current (DC) via slip rings mounted on outer shaft 802. The strength of magnetic field for each electromagnet is selected to provide magnetic bond suitable for a particular application.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. A coaxial shaft system comprising:
an inner shaft, the inner shaft including:
a first plurality of magnets located on an outer circumference of the inner shaft;
an outer shaft located coaxially around at least a portion of the inner shaft, the outer shaft including:
a second plurality of magnets located on an inner circumference of the outer shaft so that the second plurality of magnets faces towards the first plurality of magnets located on the inner shaft; and,
a support system that supports the inner shaft and the outer shaft so that the inner shaft does not come into physical contact with the outer shaft;
wherein number and location of the first plurality of magnets and the second plurality of magnets are configured so that for every magnet in the first plurality of magnets there is a corresponding magnet in the second plurality of magnets that together form a closely proximate magnetically attractive pair that have opposite poles in close proximity.

2. A coaxial shaft system as in claim 1 wherein:
the first plurality of magnets are permanent magnets; and,
the second plurality of magnets are permanent magnets.

3. A coaxial shaft system as in claim 1 wherein:
the first plurality of magnets are electromagnets; and,
the second plurality of magnets are electromagnets magnets.

4. A coaxial shaft system as in claim 1 wherein:
the first plurality of magnets are electromagnets; and,
the second plurality of magnets are permanent magnets.

5. A coaxial shaft system as in claim 1 wherein:
the first plurality of magnets are permanent magnets; and,
the second plurality of magnets are electromagnets.

6. A coaxial shaft system as in claim 1 wherein the support system comprises:
a first plurality of support structures supporting the inner shaft, each support structure in the first plurality of support structure including a bearing on which the inner shaft is mounted; and,
a second plurality of support structures supporting the outer shaft, each support structure in the second plurality of support structure including a bearing on which the outer shaft is mounted.

7. A coaxial shaft system as in claim 1:
wherein there are an even number of magnets in the first plurality of magnets and an equal even number of magnets in the second plurality of magnets;
wherein pole directions of the magnets in the first plurality of magnets are alternated so that half of the magnets in the first plurality of magnets have south poles facing outward toward the outer shaft and half of the magnets in the first plurality of magnets have north poles facing outward toward the outer shaft; and,
wherein pole directions of the magnets in the second plurality of magnets are alternated so that half of the magnets in the second plurality of magnets have south poles facing inward toward the inner shaft and half of the magnets in the second plurality of magnets have north poles facing inward toward the inner shaft.

8. A coaxial shaft system comprising:
an inner shaft,
an outer shaft located coaxially around at least a portion of the inner shaft;
a first disk connected to the inner shaft so that as the inner shaft rotates, the first disk rotates, the first disk including:
a first plurality of magnets located on a first surface of the first disk;
a second disk connected to the outer shaft so that as the outer shaft rotates, the second disk rotates, the second disk including:
a second plurality of magnets located on a second surface of the second disk, the second surface of the second disk facing towards and being in close proximity to the first surface of the first disk; and,
a support system that supports the inner shaft and the outer shaft so that the inner shaft does not come into physical contact with the outer shaft;
wherein number and location of the first plurality of magnets and the second plurality of magnets are configured so that for every magnet in the first plurality of magnets there is a corresponding magnet in the second plurality of magnets that together form a closely proximate magnetically attractive pair that have opposite poles in close proximity.

9. A coaxial shaft system as in claim 8 wherein:
the first plurality of magnets are permanent magnets; and,
the second plurality of magnets are permanent magnets.

10. A coaxial shaft system as in claim 8 wherein:
the first plurality of magnets are electromagnets; and,
the second plurality of magnets are electromagnets.

11. A coaxial shaft system as in claim 8 wherein:
the first plurality of magnets are electromagnets; and,
the second plurality of magnets are permanent magnets.

12. A coaxial shaft system as in claim 8 wherein:
the first plurality of magnets are permanent magnets; and,
the second plurality of magnets are electromagnets.

13. A coaxial shaft system as in claim 8 wherein the support system comprises:
a first plurality of support structures supporting the inner shaft, each support structure in the first plurality of support structure including a bearing on which the inner shaft is mounted; and,
a second plurality of support structures supporting the outer shaft, each support structure in the second plurality of support structure including a bearing on which the outer shaft is mounted.

14. A coaxial shaft system as in claim 8:
wherein there are an even number of magnets in the first plurality of magnets and an equal even number of magnets in the second plurality of magnets;
wherein pole directions of the magnets in the first plurality of magnets are alternated so that half of the magnets in the first plurality of magnets have south poles facing toward the second disk and half of the magnets in the first plurality of magnets have north poles facing toward the second disk; and,
wherein pole directions of the magnets in the second plurality of magnets are alternated so that half of the magnets in the second plurality of magnets have south poles facing toward the first disk and half of the magnets in the second plurality of magnets have north poles facing toward the first disk.

15. A system comprising:
a machine that supplies motive power;
a coaxial shaft system, comprising:
inner shaft, the inner shaft including:
a first plurality of magnets structurally connected to the inner shaft;
an outer shaft located coaxially around at least a portion of the inner shaft, the outer shaft including:
a second plurality of magnets structurally connected to the outer shaft so that the second plurality of magnets faces towards the first plurality of magnets; and,
a support system that supports the inner shaft and the outer shaft so that the inner shaft does not come into physical contact with the outer shaft; and,
a power transmission system that mechanically transmits power from the machine to rotate the inner shaft or the outer shaft;
wherein number and location of the first plurality of magnets and the second plurality of magnets are configured so that for every magnet in the first plurality of magnets there is a corresponding magnet in the second plurality of magnets that together form a closely proximate magnetically attractive pair that have opposite poles in close proximity with a result that there is a magnetic bond between the inner shaft and the outer shaft so that when the first of the inner shaft and the outer shaft is rotated, both the inner shaft and the outer shaft are rotated.

16. A system as in claim 15 wherein the power transmission system includes a gear box where power is mechanically transmitted from the machine to the gear box and from the gear box to the coaxial shaft system.

17. A system as in claim 15 wherein the power transmission comprises one of the following:
a pulley and belt system; or
a sprocket and chain system.

18. A system as in claim 15 wherein the second plurality of magnets is mounted on an inner circumference of the outer shaft and wherein the first plurality of magnets is mounted on an outer circumference of the inner shaft.

19. A system as in claim 15:
wherein the first plurality of magnets is mounted on a first surface of a first disk connected to the inner shaft;
wherein the second plurality of magnets are mounted on a second surface of a second disk connected to the outer shaft; and,
wherein the second surface of the second disk faces towards and is in close proximity to the first surface of the first disk.

20. A system as in claim 15 wherein the machine that supplies motive power is an electric motor.
